(19) United States
(12) Patent Application Publication
(10) Pub. No.: US 2015/0269271 A1
(43) Pub. Date: Sep. 24, 2015

(54) Method And Apparatus For Displaying A Webpage

(71) Applicant: TENCENT TECHNOLOGY (SHENZHEN) COMPANY LIMITED, Shenzhen City (CN)

(72) Inventors: Xuebin LIU, Shenzhen (CN); Yongxia LIU, Shenzhen (CN); Jiejun ZHANG, Shenzhen (CN); Kaixiang ZHANG, Shenzhen (CN)

(21) Appl. No.: 14/734,008

(22) Filed: Jun. 9, 2015

Related U.S. Application Data
(63) Continuation of application No. PCT/CN2013/088133, filed on Nov. 29, 2013.

(30) Foreign Application Priority Data
Dec. 18, 2012 (CN) 201210549940.7

(51) Int. Cl. G06F 17/30; H04L 29/08

(52) U.S. Cl. CPC G06F 17/30902; G06F 17/30893; H04L 67/02

(57) ABSTRACT

In a method for displaying a webpage includes a server that receives a webpage request from a terminal. The server obtains a webpage according to the webpage request. The server arranges a vector layout for webpage elements in the webpage. The server transmits the webpage after the vector layout arrangement to the terminal, such that the terminal displays the webpage and zooms in or zooms out the webpage elements in the webpage according to a webpage zooming instruction.

### CROSS-REFERENCE TO RELATED APPLICATIONS

This application is a continuation of International Application No. PCT/CN2013/088133, filed Nov. 29, 2013. This application claims the benefit and priority of Chinese Application No. 201210549940.7, filed Dec. 18, 2012. The entire disclosures of each of the above applications are incorporated herein by reference.

### FIELD

The present disclosure relates to information processing techniques and to a method and an apparatus for displaying a webpage.

### BACKGROUND

This section provides background information related to the present disclosure which is not necessarily prior art.

Presently, there are two main webpage displaying methods in smart terminal browser fields. In one method, a webpage processing engine (e.g., Webkit, Presto, etc.) is configured in a smart terminal to retrieve and parse a webpage and arrange the layout. This method simplifies the development of the smart terminal, but the smart terminal requires a strong hardware processing ability, e.g., high speed CPU, large memory, and high network speed, etc. In another method, a “thin client technique” is adopted. The webpage processing engine is configured at a server. Operations such as webpage retrieving, parsing, and layout arrangement are implemented by a series of background servers. The smart terminal merely needs to receive and display a webpage of which the layout has been arranged. This displaying mode is challenging to develop, but the terminal requires less hardware resources to display the webpage, e.g., less CPU, less memory, and less network resources.

### SUMMARY

This section provides a general summary of the disclosure, and is not a comprehensive disclosure of its full scope or all of its features.

According to various embodiments, a method for displaying a webpage is provided. The method includes:

receiving, by a server, a webpage request from a terminal;

obtaining, by the server, a webpage according to the webpage request;

arranging, by the server, a vector layout for webpage elements in the webpage; and

transmitting, by the server, the webpage after the vector layout arrangement to the terminal, such that the terminal displays the webpage and zooms in or zooms out the webpage elements in the webpage according to a webpage zooming instruction.

According to various embodiments, an apparatus for displaying a webpage is provided. The apparatus includes:

one or more processors;

a memory; and

one or more program modules stored in the memory and to be executed by the one or more processors, the one or more program units comprise:

a webpage request receiving unit, adapted to receive a webpage request from a terminal and obtain a webpage according to the webpage request;

a vector layout arranging unit, adapted to arrange a vector layout for webpage elements in the webpage; and

a webpage transmitting unit, adapted to transmit the webpage after the vector layout arrangement to the terminal, such that the terminal displays the webpage and zooms in or zooms out the webpage elements in the webpage according to a webpage zooming instruction.

According to various embodiments, a non-transitory computer-readable storage medium comprising a set of instructions for displaying a webpage is provided, the set of instructions to direct at least one processor to perform various acts of:

receiving a webpage request from a terminal;

obtaining a webpage according to the webpage request;

arranging a vector layout for webpage elements in the webpage; and

transmitting the webpage after the vector layout arrangement to the terminal, such that the terminal displays the webpage and zooms in or zooms out the webpage elements in the webpage according to a webpage zooming instruction.

Other aspects or embodiments of the present disclosure will be recognized by those skilled in the art in view of the description, the claims, and the drawings herein.

Further areas of applicability will become apparent from the description provided herein. The description and specific examples in this summary are intended for purposes of illustration and are not intended to limit the scope of the present disclosure.

### DRAWINGS

The drawings described herein are for illustrative purposes of various embodiments and not all possible implementations, and are not intended to limit the scope of the present disclosure.

Features of the present disclosure are illustrated by way of example and are not limited in the following figures, in which like numerals indicate like elements.

FIG. 1 is a diagram illustrating a computer system according to various embodiments.

FIG. 2 is a flowchart illustrating a method for displaying a webpage according to various embodiments.

FIG. 3 is a diagram illustrating the encapsulation of webpage elements according to various embodiments.

FIG. 4 is a diagram illustrating a webpage before a zoom out operation according to various embodiments.

FIG. 5 is a diagram illustrating the webpage after the zoom out operation according to various embodiments.

FIG. 6 is a diagram illustrating a structure of an apparatus for displaying a webpage according to various embodiments.

Corresponding reference numerals indicate corresponding parts throughout the several views of the drawings.

### DETAILED DESCRIPTION

Example embodiments will now be described more fully with reference to the accompanying drawings.

The preset disclosure will be described in further detail hereinafter with reference to accompanying drawings and examples to make the technical methods and qualities therein clearer.

For simplicity and illustrative purposes, the present disclosure is described by referring to various embodiments. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure. As used herein, the term “includes” means includes but not limited to, the term “including” means including but not limited to. The term “based on” means based at least in part on. In addition, the terms “a” and “an” are intended to denote at least one of a particular element.

Conventionally, smart terminals using the thin client technique adopt single-touch screens. The smart terminals display webpages whose layouts have been arranged by a background server. Users cannot zoom in or zoom out of the webpages freely. In contrast, various embodiments provide a method for displaying a webpage, such that a user can zoom in or zoom out the webpage displayed in a browser of a smart terminal with a multi-touch screen.

FIG. 1 is a diagram illustrating a computer system according to various embodiments. A server 110 may be a computing device capable of executing a method and apparatus of the present disclosure. The smart terminal 120 may, for example, be a device such as a smart phone, Personal Computer (PC), Personal Digital Assistant (PDA), tablet PC, etc. The terminal 120 may include a variety of operating systems such as Android, Palm OS, Symbian, Windows mobile, Linux, iPhone OS, Black Berry OS 6.0, Windows Phone, etc. If the terminal 120 executes an Android operating system, any one of the following editions may be adopted: Android Beta, Android 1.0, Cupcake (Android 1.5), Donut (Android 1.6), Eclair (Android 2.0/2.1), Froyo (Android 2.2), Gingerbread (Android 2.3), Honeycomb (Android 3.0), Ice cream Sandwich (Android 4.0), Jelly Bean (Android 4.1), etc. Some Android editions are listed above. Those with ordinary skill in the art will recognize that the methods of the present disclosure are not restricted to the above-listed editions. Other editions are also applicable.

The server 110 may vary in terms of capabilities or features. Claimed subject matter is intended to cover a wide range of potential variations. For example, the server 110 may include and execute a variety of operating systems 141 and a variety of possible applications 142, such as a webpage displaying application 145. The server 110 may include one or more non-transitory processor-readable storage media 130 and one or more processors 122 in communication with the non-transitory processor-readable storage media 130. For example, the non-transitory processor-readable storage media 130 may be a RAM memory, flash memory, ROM memory, EPROM memory, EEPROM memory, registers, hard disk, a removable disk, a CD-ROM, or any other form of non-transitory storage medium known in the art. The one or more non-transitory processor-readable storage media 130 may store sets of instructions or units and/or modules that comprise the sets of instructions, for conducting operations described in the present disclosure. The one or more processors may be configured to execute the sets of instructions and perform the operations according to various embodiments.

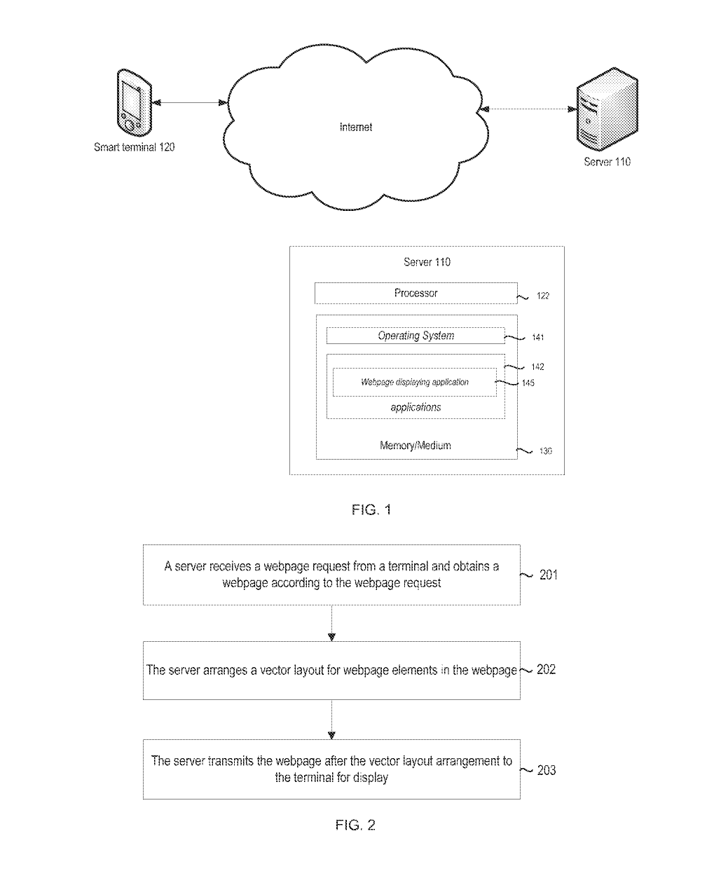

FIG. 2 is a diagram illustrating a method for displaying a webpage according to various embodiments. FIG. 2 is a simplified diagram according to various embodiments. This diagram is merely an example, which should not unduly limit the scope of the claims. One with ordinary skill in the art will recognize many variations, alternatives, and modifications.

Block 201: A server receives a webpage request from a terminal and obtains a webpage according to the webpage request. Herein, the server may obtain the webpage from a third party website according to the webpage request or obtain the webpage from a cache of the server itself according to the webpage request.

Block 202: The server obtains webpage elements in the webpage and arranges a vector layout for the webpage elements. In block 202, the server retrieves webpage elements (e.g., text, pictures, controllers, etc.) from the webpage, configures rendering attribute information for each webpage element, and encapsulates the webpage element and its rendering attribute information into a webpage element layout packet. The process of encapsulating the webpage element and its rendering attribute information into the webpage element layout packet is referred to as vector layout arrangement.

According to various embodiments, each webpage element may be arranged in a rectangle area which includes a content area (i.e., contents of the webpage element). The content area may include text, picture or controller (e.g., icon, input box, and list box), etc. The rectangle area and the content area may have different rendering attributes, e.g., color, margin width, etc. This information is determined by the rendering attribute information. Although the rectangle area is taken as an example to describe the encapsulation of the webpage element, those with ordinary skill in the art will recognize that the webpage element may also encapsulate other shapes.

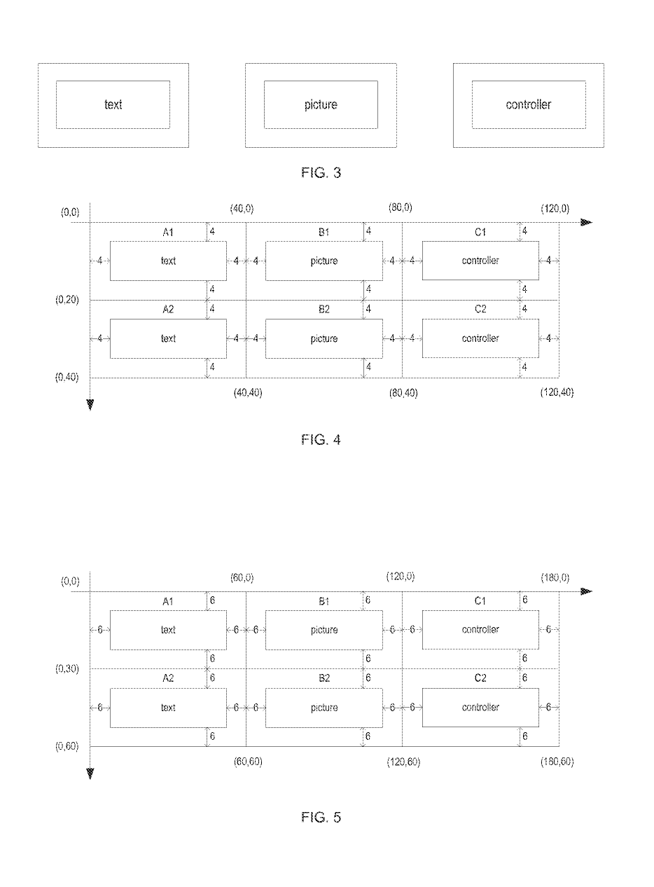

FIG. 3 is a diagram illustrating the encapsulation of a webpage element layout packet according to various embodiments. The rendering attribute information determines the way that the webpage element layout packet and the webpage elements in the webpage element layout packet are displayed. The rendering attribute information may include a common attribute which is applicable for each webpage element layout packet and a dedicated attribute which is dedicated for a specific webpage element layout packet.

According to various embodiments, a common attribute may include the following:

X: denotes X coordinate of a webpage element layout packet in a webpage document.

Y: denotes Y coordinate of the webpage element layout packet in the webpage document.

WIDTH: denotes the width of the webpage element layout packet.

HEIGHT: denotes the height of the webpage element layout packet.

BG_COLOR: denotes a background color of the webpage element layout packet.

PADDING_LEFT: denotes a left margin of the contents in the webpage element layout packet to the webpage element layout packet.

PADDING_TOP: denotes a top margin of the contents in the webpage element layout packet to the webpage element layout packet.

PADDING_RIGHT: denotes a right margin of the contents in the webpage element layout packet to the webpage element layout packet.

PADDING_BOTTOM: denotes a bottom margin of the contents in the webpage element layout packet to the webpage element layout packet.

According to various embodiments, if the webpage element is text, the rendering attribute information may further include at least one of: FONT_SIZE: size of text; FONT_STYLE: style of text (traditional, bold, Italic); FONT_COLOR: color of text; URL: link in text; VALUE: content of text. If the webpage element is a picture, the rendering attribute information of the webpage element may further include a link or a replacement text if the picture is not available. If the webpage element is a controller, the rendering attribute information of the webpage element further includes a controller type. The controller may be any one of an icon controller, a list box controller, a single-line text/password inputting box controller, a multi-line text inputting box controller, a file upload controller, a drawer controller, a single selection controller, or a multi-selection controller. The text may be traditional text or text with a hyperlink. If the attributes include a valid URL attribute, the text is hyperlink text and can be clicked; otherwise, the text is traditional text. The two kinds of texts may be displayed by different colors. For a picture, if its attribute includes a valid URL attribute, the picture is a hyperlink picture; otherwise, the picture is a traditional picture. A picture with a hyperlink may be clicked to open a new link.

Block 203: The server transmits the webpage after the vector layout arrangement to the terminal for display. In this block, the server transmits the element layout packet to the terminal which obtains the webpage elements and their rendering attribute information from the webpage element layout packet and renders the webpage elements according to the rendering attribute information to display the webpage.

In block 203, the terminal may display the shape of the webpage element layout packet as invisible.

When a user's fingers executes a zoom-in/zoom-out operation on the multi-touch screen of the terminal, the terminal detects a webpage zooming instruction and determines a zooming proportion according to the webpage zooming instruction. According to the zooming proportion, the terminal performs a vector zooming operation to the webpage element layout packet and the webpage elements, wherein the webpage element layout packet is configured as invisible.

FIG. 4 is a diagram illustrating a webpage before a zooming operation according to various embodiments. FIG. 5 is a diagram illustrating a webpage after the zooming operation is performed according to various embodiments.

As shown in FIG. 4, the server encapsulates six webpage element layout packets, which are, respectively, A1, A2, B1, B2, C1 and C2; wherein content areas of A1 and A2 are text contents, content areas of B1 and B2 are picture contents, and content areas of C1 and C2 are controller contents. The layout of the webpage element packets on the screen of the terminal is A1 (0, 0, 40, 20), A2 (0, 20, 40, 40), B1 (40, 0, 80, 20), B2 (40, 20, 80, 40), C1 (80, 0, 120, 20), and C2 (80, 20, 120, 40). If the user enlarges the webpage a certain number of times (e.g., 1.5 times) of the original size, each webpage element is multiplied by the corresponding times 1.5.

As shown in FIG. 4:

A1*1.5, area coordinates of A1 are (0, 0, 60, 30);

A2*1.5, area coordinates of A2 are (0, 30, 60, 60);

B1*1.5, area coordinates of B1 are (60, 0, 120, 30);

B2*1.5, area coordinates of B2 are (60, 30, 120, 60);

C1*1.5, area coordinates of C1 are (120, 0, 180, 30); and

C2*1.5, area coordinates of C2 are (120, 30, 180, 60).

The rendering attribute value of the area content of each area should also be multiplied by the corresponding enlarge times. According to various embodiments, the top margin of the text area in packet A1 changes from 4 to 4*1.5=6; the bottom margin of the text area in packet A1 changes from 4 to 41.5=6, the left margin of the text area in packet A1 changes from 4 to 4*1.5=6; the right margin of the text area in packet A1 changes from 4 to 41.5=6. Similarly, the multiplying operation is also performed to content areas in other packets. It can be seen from FIG. 4 and FIG. 5 that the layout of the elements is still normal after being enlarged. Although there are various kinds of webpage elements, the vector layout may be implemented by the server according to various embodiments

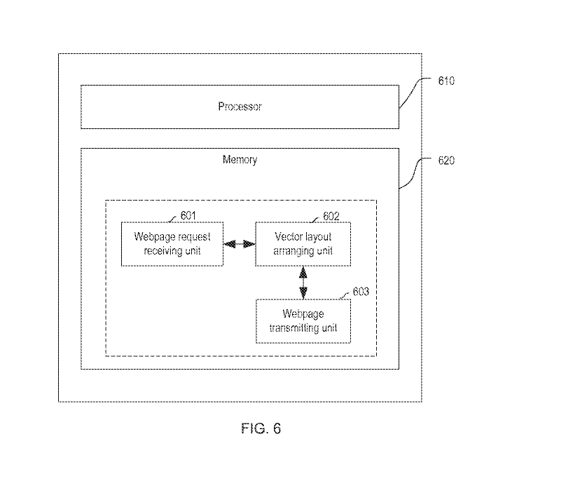

Various embodiments further provide an apparatus for displaying a webpage. As shown in FIG. 6, the apparatus includes one or more processors 610 and a memory 620. The memory 620 stores one or more program units to be executed by the one or more processors 610. The one or more program units comprise a webpage request receiving unit 601, a vector layout arranging unit 602, and a webpage transmitting unit 603.

The webpage request receiving unit 601 is adapted to receive a webpage request from a terminal and obtain a webpage according to the webpage request. The vector layout arranging unit 602 is adapted to arrange a vector layout for webpage elements in the webpage. The webpage transmitting unit 603 is adapted to transmit the webpage after the vector layout is arranged, such that the terminal displays the webpage elements in the webpage according to the webpage received. In particular, the webpage request receiving unit 601 may obtain the webpage from a third party website or from a cache of the server itself.

The rendering attribute information of the webpage element includes at least one of a position of the webpage element layout packet in the webpage, width of the webpage element layout packet, background color of the webpage element layout packet, height of the webpage element layout packet, and a position of a webpage element in the webpage element layout packet. If the webpage element includes text, the rendering attribute information may further include at least one of font size, font style, font color, and a hyperlink in the text. If the webpage element includes a picture, the rendering attribute information of the webpage element may further include a link or a replacement text if the picture is not available. If the webpage element includes a controller, the rendering attribute information of the webpage element further includes a controller type. The controller may be any one of an icon controller, a list box controller, a single-line text/password inputting box controller, a multi-line text inputting box controller, a file upload controller, a drawer controller, a single selection controller, or a multi-selection controller.

The webpage displaying method and apparatus are provided by the various embodiments. For example, the webpage displaying method may be implemented as a plug-in program installed in the terminal or as an application which can be downloaded by the user. If the method is implemented as the plug-in program, any one of the plug-in formats of ocx, dll, cab, flash plug-in, RealPlayer plug-in, MMS plug-in, MIDI plug-in, ActiveX plug-in may be selected.

In view of the above, according to various embodiments, the server receives a webpage request from the terminal, obtains a webpage according to the webpage request, arranges a vector layout for webpage elements in the webpage, and transmits the webpage whose layout is arranged to the terminal. Thus, after receiving the webpage whose layout is arranged, the terminal can zoom in/out the webpage elements in the webpage according to a webpage zooming instruction. When a user's fingers operate on a multi-touch screen, the webpage zooming instruction may be generated according to the operation of the user's fingers. According to the webpage zooming instruction, the terminal zooms in/out the webpage after the vector layout arrangement following a proportion and renders the webpage in real-time, so as to achieve a vector zooming effect. Thus, zooming of the webpage in the browser of the terminal is implemented.

What has been described and illustrated herein is a preferred example of the disclosure along with some of its variations. The terms, descriptions and figures used herein are set forth by way of illustration and are not meant as limitations. Many variations are possible within the spirit and scope of the disclosure, which is intended to be defined by the following claims—and their equivalents—in which all terms are meant in their broadest reasonable sense unless otherwise indicated.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

Reference throughout this specification to “one embodiment,” “an embodiment,” “specific embodiment,” or the like in the singular or plural means that one or more particular features, structures, or characteristics described in connection with an embodiment is included in at least one embodiment of the present disclosure. Thus, the appearances of the phrases “in one embodiment” or “in an embodiment,” “in a specific embodiment,” or the like in the singular or plural in various places throughout this specification are not necessarily all referring to the same embodiment. Furthermore, the particular features, structures, or characteristics may be combined in any suitable manner in one or more embodiments.

What is claimed is:

1. A method for displaying a webpage, comprising:
receiving, by a server, a webpage request from a terminal;
obtaining, by the server, a webpage according to the webpage request;
arranging, by the server, a vector layout for webpage elements in the webpage; and
transmitting, by the server, the webpage after the vector layout arrangement to the terminal, such that the terminal displays the webpage and zooms in or zooms out the webpage elements in the webpage according to a webpage zooming instruction.

2. The method of claim 1, wherein:
the obtaining the webpage according to the webpage request comprises:
obtaining, by the server, the webpage from a third party website according to the webpage request; or
obtaining, by the server, the webpage from a cache of the server according to the webpage request.

3. The method of claim 1, wherein:
the arranging the vector layout of the webpage elements in the webpage comprises:
retrieving, by the server, the webpage elements in the webpage, configuring rendering attribute information for each webpage element, and encapsulating the webpage element and its rendering attribute information into a webpage element layout packet, such that when the terminal displays the webpage, the terminal parses the webpage element layout packet to obtain the webpage element and the rendering attribute information and renders the webpage element layout packet and the webpage element according to the rendering attribute information.

4. The method of claim 3, wherein the rendering attribute information of the webpage element comprises at least one of:
a position of the webpage element layout packet in the webpage;
width of the webpage element layout packet;
background color of the webpage element layout packet;
height of the webpage element layout packet; and
a position of the webpage element in the webpage element layout packet.

5. The method of claim 4, wherein the webpage element is text; the rendering attribute information of the webpage element further comprises any one of:
font size;
font style;
font color; and
hyperlink in the text.

6. The method of claim 4, wherein the webpage element is a picture; the rendering attribute information of the webpage element further comprises a link for the picture or default replacement text if the picture is unavailable.

7. The method of claim 4, wherein the webpage element is a controller; the rendering attribute information of the webpage element further comprises a controller type; the controller comprises at least one of:
an icon controller;
a list box controller;
a single-line text/password inputting box controller;
a multi-line text inputting box controller;
a file uploading controller;
a drawer controller;
a single selection controller; and
a multi-selection controller.

8. The method of claim 1, further comprising:
detecting, by the terminal, a webpage zooming instruction;
determining, by the terminal, a webpage zooming proportion according to the webpage zooming instruction; and
performing, by the terminal, a vector zooming in or zooming out operation to the webpage element layout packet and the webpage elements in the webpage according to the webpage zooming proportion; wherein the webpage element layout packet is configured as invisible.

9. An apparatus for executing plot instructions for displaying a webpage, comprising:
one or more processors;
a memory; and
one or more program modules stored in the memory and to be executed by the one or more processors, the one or more program units comprise:
a webpage request receiving unit, adapted to receive a webpage request from a terminal and obtain a webpage according to the webpage request;
a vector layout arranging unit, adapted to arrange a vector layout for webpage elements in the webpage; and
a webpage transmitting unit, adapted to transmit the webpage after the vector layout arrangement to the terminal, such that the terminal displays the webpage and zooms in or zooms out the webpage elements in the webpage according to a webpage zooming instruction.

10. The apparatus of claim 9, wherein:
the webpage request receiving unit is further adapted to obtain the webpage from a third party website or from a cache of the apparatus according to the webpage request.

11. The apparatus of claim 9, wherein:
the vector layout arranging unit is further adapted to retrieve the webpage elements in the webpage, configure rendering attribute information for each webpage element and encapsulate the webpage element and its rendering attribute information into a webpage element layout packet, such that when the terminal displays the webpage, the terminal parses the webpage element layout packet to obtain the webpage element and the rendering attribute information and renders the webpage element layout packet and the webpage element according to the rendering attribute information.

12. The apparatus of claim 11, wherein the rendering attribute information of the webpage element comprises at least one of:
a position of the webpage element layout packet in the webpage;
width of the webpage element layout packet;
background color of the webpage element layout packet;
height of the webpage element layout packet; and
a position of the webpage element in the webpage element layout packet.

13. The apparatus of claim 12, wherein the webpage element is text; the rendering attribute information of the webpage element further comprises any one of:
font size;
font style;
font color; and
hyperlink in the text.

14. The apparatus of claim 12, wherein the webpage element is a picture; the rendering attribute information of the webpage element further comprises a link for the picture or default replacement text if the picture is unavailable.

15. The apparatus of claim 12, wherein the webpage element is a controller; the rendering attribute information of the webpage element further comprises a controller type; the controller comprises at least one of:
an icon controller;
a list box controller;
a single-line text/password inputting box controller;
a multi-line text inputting box controller;
a file uploading controller;
a drawer controller;
a single selection controller; and
a multi-selection controller.

16. A non-transitory computer-readable storage medium comprising a set of instructions for displaying a webpage, the set of instructions to direct at least one processor to perform acts of:
receiving a webpage request from a terminal;
obtaining a webpage according to the webpage request;
arranging a vector layout for webpage elements in the webpage; and
transmitting the webpage after the vector layout arrangement to the terminal, such that the terminal displays the webpage and zooms in or zooms out the webpage elements in the webpage according to a webpage zooming instruction.

17. The non-transitory computer-readable storage medium of claim 16, wherein:
the arranging the vector layout of the webpage elements in the webpage comprises:
retrieving the webpage elements in the webpage, configuring rendering attribute information for each webpage element, and encapsulating the webpage element and its rendering attribute information into a webpage element layout packet, such that when the terminal displays the webpage, the terminal parses the webpage element layout packet to obtain the webpage element and the rendering attribute information and renders the webpage element layout packet and the webpage element according to the rendering attribute information.
